(19) United States
(12) Patent Application Publication
(10) Pub. No.: US 2007/0267547 A1
(43) Pub. Date: Nov. 22, 2007

(54) Flexible reefing loops for parachutes

(76) Inventor: Elsa Hennings, Ridgecrest, CA (US)

Correspondence Address: NAVAIRWD COUNSEL GROUP, 575 "I" AVE, SUITE 1 (CODE K00000E), BUILDING 36, ROOM 2308, POINT MUGU, CA, 93042-5049, US

(21) Appl. No.: 11/443,846

(22) Filed: May 22, 2006

(51) Int. Cl. B64D 17/02

(52) U.S. Cl. 244/145

(57) ABSTRACT

A reefing loop assembly which is attached to the skirt of a parachute canopy to secure a reefing loop to a parachute. The reefing loop assembly is fabricated from a flexible fabric to allow a parachute to be packed without damaging the parachute during packing.

### BACKGROUND OF THE INVENTION

1. Field of the Invention

The present invention relates generally to parachutes. More specifically, the present invention relates to a flexible reefing loop for use on a parachute.

2. Description of the Prior Art.

As a parachute deploys, the force applied to the payload attached to the parachute is proportional to the square of the velocity. Large parachutes that are deployed at a high rate of speed generate a very large force, which either destroys the parachute or the payload. In some cases, smaller parachutes can be deployed to slow the payload down prior to the deployment of the large parachute, but in most cases, there is neither room for another parachute, nor time available to deploy both a large and a smaller parachute prior to ground impact. Therefore, a method of temporarily reducing the drag area of a single large parachute to prevent overloading was highly desirable and needed to prevent parachute and/or payload destruction.

In the past, a short length of line routed through steel rings attached at the skirt of the parachute, was utilized to limit the initial drag area of the parachute. This short length of line, referred to as a reefing line, formed a circle at the skirt of the parachute. Pyrotechnic line cutters were used to sever the line at a specific time, allowing the parachute to fully inflate once the payload had slowed down. This technique has been used since the 1940's, and works well unless the parachute is packed to a high density due to volume constraints.

When the parachute is packed, the parachute is pushed into a container using a hydraulic cylinder which can generate a large amount of force. While parachute fabrics compress easily when the parachute is packed, the parachute's steel rings do not, and a significant amount of effort must by made to prevent the rings from damaging the parachute fabric, the reefing line, the line cutters, or other rings. Since damage occurs more frequently as force is increased on the parachute, the steel rings severely limit the density to which a parachute can be packed.

Thus, there is a need to prevent damage to the parachute fabrics caused by the parachute's steel rings, while allowing the parachute to be densely packed and increase the size of the payload the parachute can accommodate.

### SUMMARY OF THE INVENTION

The present invention overcomes some of the problems of the past including those mentioned above in that it comprises a relatively simple in design, yet highly effective flexible fabric loop/reefing loop assemblies for securing a reefing line to the skirt of a parachute.

A reefing loop assembly is designed to replace each of the large steel rings which are currently used to secure a reefing line to the skirt of a parachute. Each reefing loop assembly is fabricated from a flexible low-friction fabric material such as Teflon which has a tubular shape. Inserted within the tubular low-friction flexible fabric material is a structural fabric strip, such as Kevlar, which strengthens the reefing loop assembly. A reefing loop assembly is sown to the skirt of the parachute at each suspension line attachment point. The reefing line passes through an opening formed by each reefing loop assembly and a suspension line attachment loop. The reefing line is then finger trapped to itself to form a complete circle.

A plurality of pyrotechnic line cutters are used to sever the reefing line at a specific time, allowing the reefing line ends to slide through the reefing loop assemblies, which allows parachute to fully inflate once the payload has slowed down to a speed at which damage will not occur.

### BRIEF DESCRIPTION OF THE DRAWINGS

FIG. 1 illustrates a conventional parachute having a payload attached to the parachute in an early stage of deployment;

FIG. 2 illustrates the parachute of FIG. 1 fully deployed with the reefing line severed from the parachute;

FIG. 3 illustrates a partial view of the skirt of a parachute which utilizes steel rings to secure the reefing line to the parachute;

FIG. 4 illustrates a partial view of the skirt of the parachute of FIG. 1 and one of the flexible fabric loop assemblies which secure the reefing line to the parachute;

FIGS. 5 and 5A illustrate detailed views of the flexible fabric loop assembly for one of the reefing loops of the parachute; and

FIGS. 6 an 6A illustrate detailed views of the structure for attaching a parachute suspension line to the skirt of the parachute canopy.

### DETAILED DESCRIPTION OF A PREFERRED EMBODIMENT

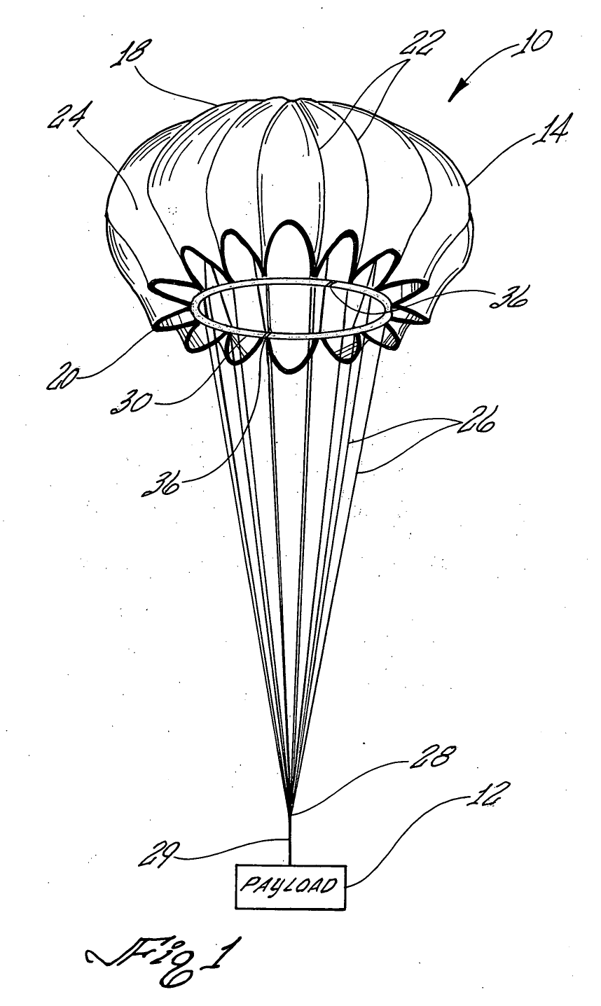

Referring to FIG. 1, there is shown a conventional parachute 10 having a payload 12 attached to the parachute 10 in an early stage of the parachute's deployment.

Parachute 10 comprises a generally circular canopy 14 which has an upper or apex area 18 and a skirt area 20. The circular canopy 14 of parachute 10 has a plurality of equally spaced apart radial seams 22 and a plurality of equally sized gores 24. The radial seams 22 are utilized to secure adjacent gores 24 of the canopy 14 together. The circular canopy 14 of parachute 10 may be fabricated from well known, commercially available parachute material such as nylon.

Parachute 10 also includes a plurality of equally spaced apart suspension lines 26 each of which is attached at one end to the skirt 20 of canopy 14 and at the opposite end of a riser 29. The other end of the riser 29 attaches to payload 12.

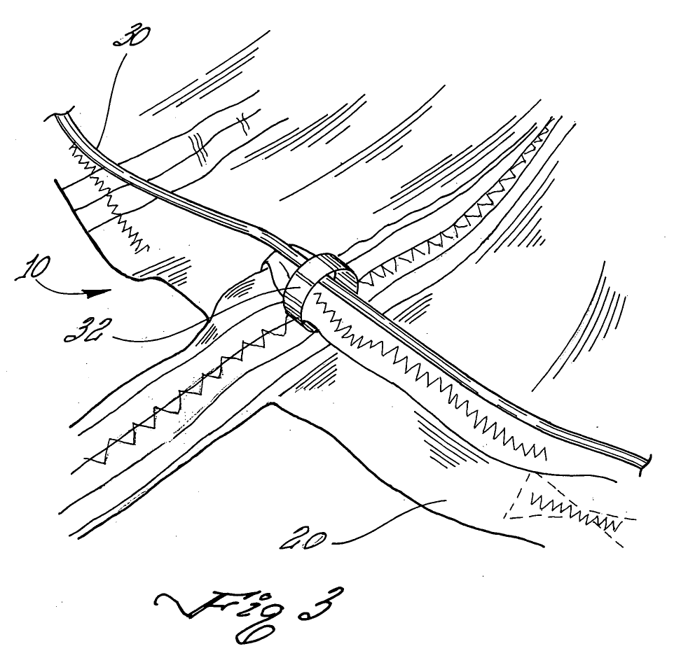

Parachute 10 also has a reefing line 30 positioned around the skirt of parachute 10. Reefing line 30 is a short length of line routed through steel reefing rings 32 (FIG. 3) attached at the skirt 20 of the parachute 10, is utilized to limit the initial drag area of the parachute. The reefing line 30 also allows the canopy 14 of parachute 10 to be packed and to open in a controlled manner.

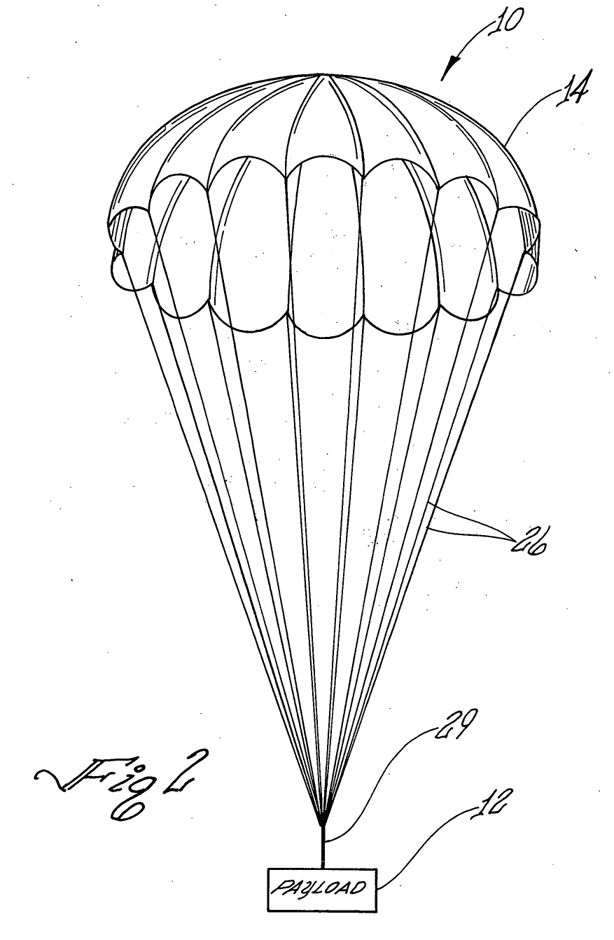

Referring to FIGS. 1 and 2, this short length of line 30 forms a circle at the skirt 20 of the parachute 10. Pyrotechnic line cutters 36 are generally used to sever the reefing line 30 at a specific time, allowing the parachute 10 to fully inflate once the payload 12 has slowed down. FIG. 2 illustrates the canopy 14 of parachute 10 fully inflated with the reefing line 20 severed from parachute 10. At this point in time parachute 10 has opened and is falling steadily. A state of equilibrium exist in which the resultant force of drag and lift acting upon the falling parachute is equal to the weight of the parachute 10 and the payload 12.

Referring to FIGS. 1, 2 and 3, large steel reefing rings 32 attached to the skirt 20 of parachute 10 are used to secure the reefing line 30 to parachute 10. The steel reefing rings 32 are equally spaced apart about the skirt 20 of parachute 10. When the parachute 10 begins to inflate, the skirt 20 of parachute 10 can only expand to the circle formed by the reefing line 30 in the manner illustrated in FIG. 1. After a length of time in which the velocity of the payload 12 has sufficiently slowed down, pyrotechnic line cutters 36 fire which sever the reefing line 30. Without the restraining force of the reefing line 30, the parachute skirt 20 is allowed to fully inflate as depicted in FIG. 2.

Unfortunately, while parachute fabrics generally compress easily, the steel reefing rings 32 do not, and a significant amount of effort must by made to prevent the rings from damaging the parachute fabric, the reefing line 30, the line cutters 36, or other rings. Since the damage occurs more frequently as the force required to pack parachute 10 is increased, the steel rings 32 severely limit the density to which a parachute 10 can be packed.

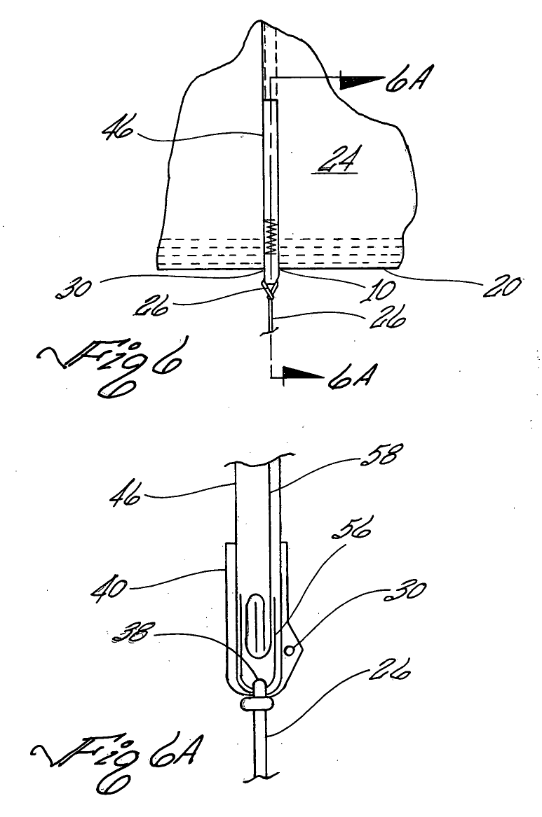

Referring now to FIGS. 1, 4, 5 and 5A, an alternative to using steel rings 32 (FIG. 3) to secure the reefing line 30 to the skirt 20 of parachute 10 is a reefing loop assembly 40 which is shown in FIGS. 5 and 5A. The reefing loop assembly 40 includes a flexible fabric material 42 which has a tubular shape and is fabricated from a low friction material such as Teflon. Inserted within the flexible fabric material 42 is a Kevlar strip 44, such as Kevlar, which strengthens the reefing loop assembly 40.

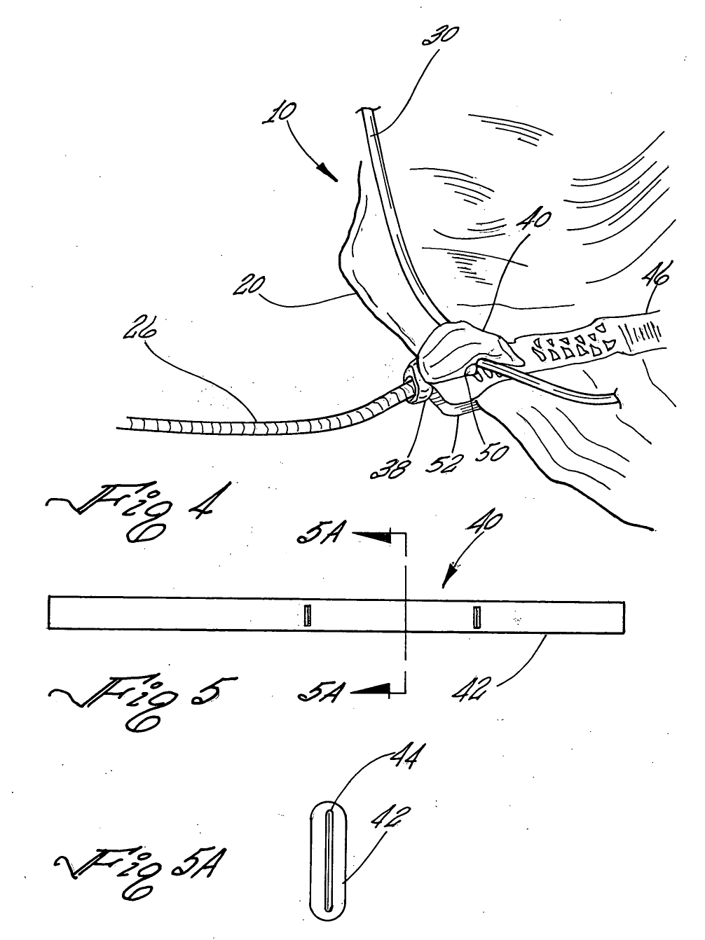

Each suspension line 26 includes a suspension line loop 38 at the end of the suspension line 26 attached to the skirt 20 of parachute 10 (FIG. 4). The suspension line loop 38 allows a user to attach the suspension line 26 to the skirt 20 of parachute 10 by looping the suspension line 26 through the loop 38 of suspension line 26.

Referring to FIGS. 1 and 4, each reefing loop assembly 40 is sewn onto the parachute skirt 20 at a radial tape 46. Each radial tape 46 is aligned with one of the radial seams 22 on the canopy 14 of parachute 10. The reefing line 30 passes through an opening 50 formed between the reefing loop assembly 40 and a radial attachment loop 52 at each radial seam 22 of the canopy 14 of parachute 10. The reefing line is also routed through reefing line cutters 36 at two opposing radial seams 22 of the canopy 14 of parachute 10. The reefing line 30 is fingertrapped to itself to form a complete circle which remains intact until the reefing line cutters 36 severe the reefing line 30 from the parachute 10.

Referring to FIGS. 1, 6 and 6A, FIG. 6A illustrates a side view of the reefing loop assembly 40 and parachute structure which is utilized to secure the reefing line 30 and suspension line loop 38 for each of the suspension lines 26 to the skirt 20 of the parachute 10. As shown in FIG. 6A, the reefing loop assembly 40 forms the outer most portion of the parachute structure used to support the suspension lines 26 and reefing line 30. The reefing loop assembly 40 is attached to the radial tape 46 by sewing the reefing loop assembly 40 onto the radial tape 46. Located inside the radial tape 46 is a layer of fabric 36, such as kevlar, which is a buffer between the radial tape 46 and the parachute cloth 58.

From the foregoing, it may readily be seen the present invention comprises a new, unique and exceedingly useful flexible reefing loop assembly for use in securing a reefing line to a parachute, which constitutes a considerable improvement over the known prior art. Obviously, many modifications and variations of the present invention are possible in light of the above teachings. It is to be understood that within the scope of the appended claims the invention may be practiced otherwise than as specifically describer.

What is claimed is:

1. A parachute for carrying a payload comprising:
(a) a generally circular canopy having an apex, a skirt, a plurality of equally spaced apart radial seams and a plurality of equally sized gores, wherein said radial seams secure adjacent gores of the canopy of said parachute together;
(b) a plurality of equally spaced apart suspension lines, each of said suspension lines having one end of said suspension line attached to the skirt of said canopy and an opposite end;
(c) a riser having one end connected to the opposite end of each of said suspension lines and another end connected to said payload;
(d) a reefing line positioned around the skirt of said canopy; and
(e) a plurality of reefing loop assemblies attached to the skirt of said parachute, each of said reefing loop assemblies being fabricated from a low-friction flexible fabric material and aligned with one of the radial seams on the canopy of said parachute, wherein said reefing line passes through an opening formed by each of said reefing loop assemblies forming a circle around the skirt of said parachute.

2. The parachute of claim 1 wherein said reefing loop assemblies prevent damage to said parachute when said parachute is packed prior to said parachute being deployed and opened in the atmosphere.

3. The parachute of claim 1 wherein the low-friction flexible fabric material used to fabricate each of said reefing loop assemblies comprises teflon which has a tubular shape.

4. The parachute of claim 3 wherein a structural fabric strip comprising kevlar is inserted into the low-friction flexible fabric material for each of said reefing loop assemblies to strengthen each of said reefing loop assemblies.

5. The parachute of claim 1 further comprising a pair of reefing line cutters positioned on said reefing line at two opposing radial seams of the canopy of said parachute, wherein said reefing line cutters when activated severing said reefing line from said parachute.

6. The parachute of claim 1 wherein said reefing loop assemblies replace attached at the skirt of said parachute to prevent damage to said parachute when said parachute is packed prior to deployment.

7. The parachute of claim 1 wherein each of said reefing loop assemblies is sown onto the skirt of said parachute attaching said reefing loop assembly to the skirt of said parachute.

8. A parachute for carrying a payload comprising:
(a) a generally circular canopy having an apex, a skirt, a plurality of equally spaced apart radial seams and a plurality of equally sized gores, wherein said radial seams secure adjacent gores of the canopy of said parachute together;
(b) a plurality of equally spaced apart suspension lines, each of said suspension lines having one end of said suspension line attached to the skirt of said canopy and an opposite end, wherein each suspension line includes a suspension line loop at the end of said suspension line attached to the skirt of said parachute, said suspension line loop allowing a user to attach said suspension line to the skirt of said parachute by looping the suspension line through the suspension line loop for said suspension line;
(c) a riser having one end connected to the opposite end of each of said suspension lines and another end connected to said payload;
(d) a reefing line positioned around the skirt of said canopy;
(e) a plurality of reefing loop assemblies positioned on the skirt of said parachute, each of said reefing loop assemblies being attached to a radial tape aligned with one of the radial seams on the canopy of said parachute, each of said reefing loop assemblies being fabricated from a low-friction flexible fabric material and aligned with one of the radial seams on the canopy of said parachute; and
(f) said reefing line passing through an opening formed by each of said reefing loop assemblies and a radial attachment loop located at each radial seam of the canopy of said parachute to form a circle around the skirt.

9. The parachute of claim 8 wherein said reefing loop assemblies prevent damage to said parachute when said parachute is packed prior to said parachute being deployed and opened in the atmosphere.

10. The parachute of claim 8 wherein the low-friction flexible fabric material used to fabricate each of said reefing loop assemblies comprises teflon which has a tubular shape.

11. The parachute of claim 10 wherein a structural fabric strip comprising kevlar is inserted into the low-friction flexible fabric material for each of said reefing loop assemblies to strengthen each if said reefing loop assemblies.

12. The parachute of claim 8 further comprising a pair of reefing line cutters positioned on said reefing line at two opposing radial seams of the canopy of said parachute, wherein said reefing line cutters when activated severing said reefing line from said parachute.

13. The parachute of claim 8 wherein said reefing loop assemblies replace steel rings attached at the skirt of said parachute to prevent damage to said parachute when said parachute is packed prior to deployment.

14. The parachute of claim 8 wherein each of said reefing loop assemblies is sown onto the skirt of said parachute attaching said reefing loop assembly to the skirt of said parachute.

15. A parachute for carrying a payload comprising:
(a) a generally circular canopy having an apex, a skirt, a plurality of equally spaced apart radial seams and a plurality of equally sized gores, wherein said radial seams secure-adjacent gores of the canopy of said parachute together;
(b) a plurality of equally spaced apart suspension lines, each of said suspension lines having one end of said suspension line attached to the skirt of said canopy and an opposite end, wherein each suspension line includes a suspension line loop at the end of said suspension line attached to the skirt of said parachute, said suspension line loop allowing a user to attach said suspension line to the skirt of said parachute by looping the suspension line through the suspension line loop for said suspension line;
(c) a riser having one end connected to the opposite end of each of said suspension lines and another end connected to said payload;
(d) a reefing line positioned around the skirt of said canopy;
(e) a plurality of reefing loop assemblies positioned on the skirt of said parachute, each of said reefing loop assemblies being attached to a radial tape aligned with one of the radial seams on the canopy of said parachute, each of said reefing loop assemblies being fabricated from a low-friction flexible fabric material and aligned with one of the radial seams on the canopy of said parachute, each of said reefing loop assemblies including a structural fabric strip consisting of kevlar which is inserted into the low-friction flexible fabric material;
(f) a structural fabric strip consisting of kevlar which is inserted into the low-friction flexible fabric material for each of said reefing loop assemblies to strengthen each of said reefing loop assembly;
(g) said reefing line passing through an opening formed by each of said reefing loop assemblies and a radial attachment loop located at each radial seam of the canopy of said parachute to form a circle around the skirt.

16. The parachute of claim 15 wherein said reefing loop assemblies prevent damage to said parachute when said parachute is packed prior to said parachute being deployed and opened in the atmosphere.

17. The parachute of claim 15 further comprising a pair of reefing line cutters positioned on said reefing line at two opposing radial seams of the canopy of said parachute, wherein said reefing line cutters when activated severing said reefing line from said parachute.

18. The parachute of claim 15 wherein said reefing loop assemblies replace steel rings attached at the skirt of said parachute to prevent damage to said parachute when said parachute is packed prior to deployment.

19. The parachute of claim 15 wherein each of said reefing loop assemblies is sown onto the skirt of said parachute attaching said reefing loop assembly to the skirt of said parachute.
